(19) United States
(12) Patent Application Publication
(10) Pub. No.: US 2024/0086850 A1
(43) Pub. Date: Mar. 14, 2024

(54) METHOD, APPARATUS, DEVICE AND STORAGE MEDIUM FOR DATA PROCESSING

(71) Applicant: Beijing Zitiao Network Technology Co., Ltd., Beijing (CN)

(72) Inventors: Xiaojun Yang, Beijing (CN); Peng Chen, Beijing (CN); Nayun Bian, Beijing (CN); Wenhan Li, Beijing (CN); Shuai Zhang, Beijing (CN)

(21) Appl. No.: 18/517,846

(22) Filed: Nov. 22, 2023

(30) Foreign Application Priority Data
Dec. 22, 2022 (CN) 202211659077.0

(51) Int. Cl. G06Q 10/10

(52) U.S. Cl. CPC G06Q 10/103

(57) ABSTRACT

A method, apparatus, device, and storage medium for data processing. The method includes: obtaining a business object topology map and displaying the business object topology map on a current interface; where the business object topology map includes a plurality of business objects; receiving data processing logic edited by a user for at least one business object in the business object topology map; parsing the data processing logic to obtain a logical topology map corresponding to the data processing logic; obtaining instance data corresponding to the at least one business object; and processing the instance data based on the logical topology map to obtain a processing result. The method improves efficiency and accuracy of business data processing.

### CROSS REFERENCE

This application claims the priority to Chinese Patent Application No. 202211659077.0 filed on Dec. 22, 2022 and entitled “Method, Apparatus, Device and Storage Medium for Data Processing”, which is hereby incorporated by reference in its entirety.

### FIELD

The embodiments of the present disclosure relate to the field of data processing technology, and in particular to a method, apparatus, device, and storage medium for data processing.

### BACKGROUND

Existing project management software lacks calculation capability like formulas. If users want to do some automatic calculation on complex data, they still need to manually perform statistics, which is inefficient and accurate. Excel or some online documents have similar formula calculation capabilities, but they can only process data without business meanings. In most businesses, data carries business attributes, which are not supported by existing capabilities if they want to be applied to calculations.

### SUMMARY

The embodiments of the present disclosure provide a method, apparatus, device, and storage medium for data processing, which may realize the logical processing capability of processing business data, and thus improving efficiency and accuracy of business data processing.

In a first aspect, the embodiments of the present disclosure provide a method for data processing, including:
obtaining a business object topology map and displaying the business object topology map on a current interface; wherein the business object topology map comprises a plurality of business objects;
receiving data processing logic edited by a user for at least one business object in the business object topology map;
parsing the data processing logic to obtain a logical topology map corresponding to the data processing logic; wherein the logical topology map includes a plurality of logical nodes;
obtaining instance data corresponding to the at least one business object; and
processing the instance data based on the logical topology map to obtain a processing result.

According to a second aspect, the embodiments of the present disclosure also provide a data processing apparatus, including:
a business object topology map obtaining module configured to obtain a business object topology map and display the business object topology map on a current interface; wherein the business object topology map comprises a plurality of business objects;
a data processing logic obtaining module configured to receive data processing logic edited by a user for at least one business object in the business object topology map;
a logical topology map obtaining module configured to parse the data processing logic to obtain a logical topology map corresponding to the data processing logic; where the logical topology map includes a plurality of logical nodes;
an instance data obtaining Module configured to obtain instance data corresponding to the at least one business object; and
a data processing module configured to process the instance data based on the logical topology map to obtain a processing result.

According to a third aspect, the embodiments of the present disclosure also provide an electronic device, including:
one or more processors;
a storage apparatus for storing one or more programs,
when the one or more programs are executed by the one or more processors, the one or more processors implement the method for data processing as described in the embodiments of the present disclosure.

According to a fourth aspect, the embodiments of the present disclosures also provide a storage medium containing computer-executable instructions, when executed by a computer processor, the computer-executable instructions perform the method for data processing as described in the embodiments of the present disclosures.

The embodiments of the present disclosure disclose a method for data processing, apparatus, device, and storage medium, which obtain a business object topology map and display the business object topology map on a current interface; wherein the business object topology map comprises a plurality of business objects; receive data processing logic edited by a user for at least one business object in the business object topology map; parse the data processing logic to obtain a logical topology map corresponding to the data processing logic; wherein the logical topology map includes a plurality of logical nodes; obtain instance data corresponding to the at least one business object; and process the instance data based on the logical topology map to obtain a processing result. The method for data processing provided in the embodiments of the present disclosure converts the data processing logic composed of at least one business object into a logical topology map, processes instance data of the at least one business object based on the logical topology map, and thus realizing logical processing capability in processing business data, and improving efficiency and accuracy of business data processing.

### BRIEF DESCRIPTION OF THE DRAWINGS

In conjunction with the accompanying drawings and with reference to the following detailed implementations, the above and other features, advantages and aspects of the various embodiments of the present disclosure will become more apparent. Throughout the drawings, the same or similar reference numerals indicate the same or similar elements. It should be understood that the drawings are illustrative and the originals and elements are not necessarily drawn to scale.

FIG. 1 is a schematic flowchart of a method for data processing provided in an embodiment of the present disclosure.

FIG. 2 is an example diagram of a business object topology provided in an embodiment of the present disclosure.

FIG. 3 is an example diagram of generating data processing logic provided in an embodiment of the present disclosure.

FIG. 4 is an example diagram of a logical topology map provided in an embodiment of the present disclosure.

FIG. 5 is a structural schematic diagram of a data processing apparatus provided in an embodiment of the present disclosure.

FIG. 6 is a structural schematic diagram of an electronic device provided in an embodiment of the present disclosure.

### DETAILED DESCRIPTION

The following will describe the embodiments of the present disclosure in more detail with reference to the accompanying drawings. Although some embodiments of the present disclosure are shown in the drawings, it should be understood that the present disclosure can be implemented in various forms and should not be construed as limited to the embodiments set forth herein. On the contrary, these embodiments are provided for a more thorough and complete understanding of the present disclosure. It should be understood that the drawings and embodiments of the present disclosure are provided for illustrative purposes only and are not intended to limit the scope of protection of the present disclosure.

It should be understood that the various steps described in the method implementation of this disclosure can be executed in different orders and/or in parallel. In addition, the method implementation can include additional steps and/or the steps as shown may be omitted. The scope of this disclosure is not limited in this regard.

The term “including” and its variations as used herein are non-exclusive inclusion, i.e. “including but not limited to”. The term “based on” means “at least partially based on”. The term “one embodiment” means “at least one embodiment”; the term “another embodiment” means “at least one additional embodiment”; and the term “some embodiments” means “at least some embodiments”. Relevant definitions of other terms will be given in the following description.

The concepts of “first” and “second” mentioned in this disclosure are only used to distinguish different apparatuses, modules, or units, but are not used to limit the order or interdependence of the functions performed by these apparatuses, modules, or units.

The modifications of “one” and “a plurality of” mentioned in this disclosure are illustrative but not limiting. Those skilled in the art should understand that unless otherwise indicated in the context, they should be understood as “one or more”.

The names of the messages or information interacted between a plurality of apparatuses in this public implementation are for illustrative purposes only, which are not intended to limit the scope of these messages or information.

It will be appreciated that, before using the technical solutions disclosed in the various embodiments of the present disclosure, the user shall be informed of the type, application scope, and application scenario of the personal information involved in this disclosure in an appropriate manner and the user's authorization shall be obtained, in accordance with relevant laws and regulations.

For example, in response to receiving an active request from a user, a prompt message is sent to the user to explicitly prompt the user that the operation requested to be performed will require acquiring and using personal information of the user. Thus, the user can autonomously select whether to provide personal information to software or hardware such as electronic devices, applications, servers, or storage media that perform operations of the disclosed technical solution, based on the prompt message.

As an optional but non-limiting implementation, in response to receiving an active request from the user, prompt information is sent to the user, for example, in the form of a pop-up window, and the pop-up window may present the prompt information in the form of text. In addition, the pop-up window may also carry a selection control for the user to select whether he/she “agrees” or “disagrees” to provide personal information to the electronic device.

It can be understood that the above notification and user authorization process are only illustrative which do not limit the implementation of this disclosure. Other methods that meet relevant laws and regulations can also be applied to the implementation of this disclosure.

It can be understood that data involved in this technical solution (including but not limited to the data itself, acquisition or use of the data) should comply with the requirements of corresponding laws, regulations and relevant provisions.

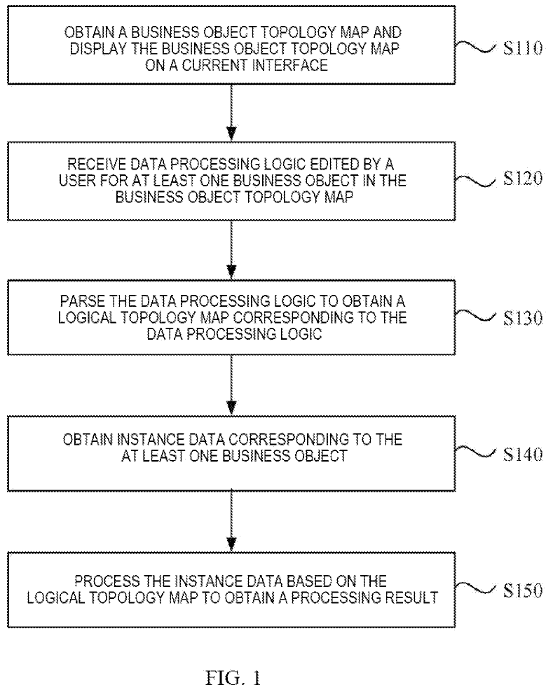

FIG. 1 is a schematic flowchart of a method for data processing according to an embodiment of the present disclosure. The present disclosure is applicable to the case that logical processing is performed on business data. The method may be performed by a data processing apparatus, the apparatus may be implemented in software and/or hardware form, optionally, may be implemented by an electronic device, and the electronic device may be a mobile terminal, PC or server.

As shown in FIG. 1, the method includes:

S110, obtaining a business object topology map and displaying the business object topology map on a current interface; wherein the business object topology map comprises a plurality of business objects.

The business object topology map includes a plurality of business objects, and each business object carries attribute information. The business object topology map may be topological graphic data pre-configured by users according to actual business needs. In the business object topology map, each business object corresponds to a node. In this embodiment, the business object topology map may have a tree structure, and the business object topology map includes a plurality of levels, each level including at least one business object. The attribute information can include information such as a data type and sub-business objects of the business object.

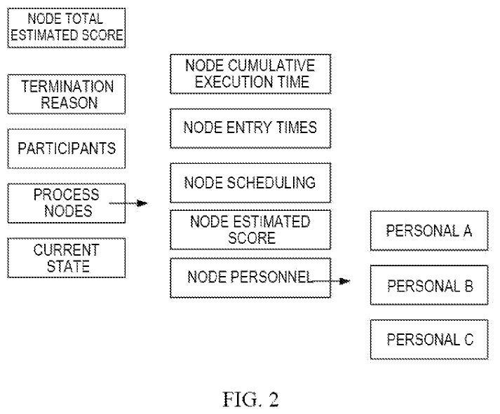

In this embodiment, when a user enters a data interface corresponding to a certain business through a data processing tool, the business object topology map of the business can be called through a business object topology map interface, and the business object topology map can be displayed on a current interface. In this embodiment, business objects of all levels of the business object topology map can be displayed in the interface. Alternatively, only the business objects of the first few levels can be displayed, and when the user's display operation is detected, the business objects of the lower levels can be displayed then. As an example, FIG. 2 is an example diagram of a business object topology map in an embodiment of the present disclosure. As shown in FIG. 2, business objects are arranged according to hierarchical relationships to form the business object topology map. In the business object topology map, the business objects of the first level include: node total estimated score, termination reason, participants, process nodes, and current state; the business objects of the second level corresponding to process nodes include node cumulative execution time, node entry times, node scheduling, node estimated score, and node personnels. FIG. 2 is just a simple example of the business object topology map. The objects of the second level corresponding to other business objects of the first level is not shown in the drawings. The business objects of the third level corresponding to the node personnels include personnel A, personnel B, and personnel C.

S120, receiving data processing logic edited by a user for at least one business object in the business object topology map.

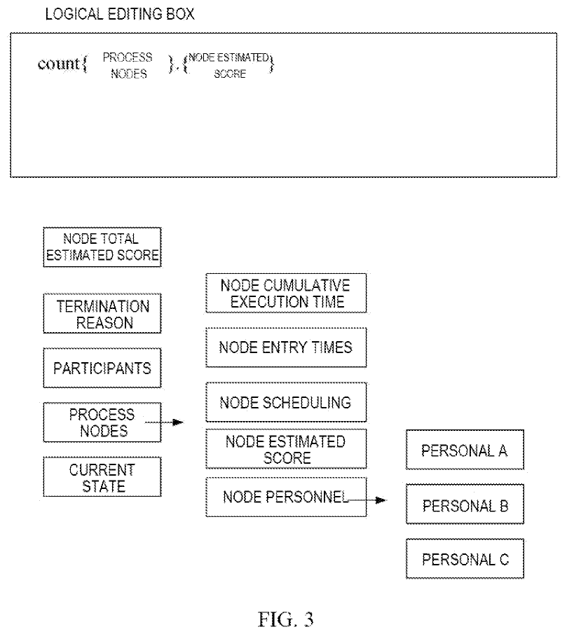

In this embodiment, a logical editing box (such as a formula editing box) is provided in the interface. The user selects at least one required business object from the displayed business object topology map according to business needs, and uses a logical function to connect the selected business object, thereby establishing a logical relationship of at least one business object and obtaining the data processing logic of the at least one business object. In an example, FIG. 3 is an example diagram of generating data processing logic in this embodiment. As shown in FIG. 3, a logical editing box is provided above the business object topology map. In this editing box, the user selects two business objects, “process node” and “node estimated score”, and uses the “count” function and “.” function to establish a connection between the two business objects, thus obtaining: a logical relationship of “count {process node}. {node estimation}”, that is, a calculation formula.

S130, parsing the data processing logic to obtain a logical topology map corresponding to the data processing logic.

The logical topology map includes a plurality of logical nodes. In this embodiment, the logical topology map can be understood as a syntax topology map. In this embodiment, the logical topology map can be a logic tree, that is, a syntax tree. Existing parsing tools may be used to parse the data processing logic.

Specifically, the method of parsing the data processing logic to obtain the logical topology map corresponding to the data processing logic includes: performing format transformation on the data processing logic to obtain target data processing logic; and parsing the target data processing logic by using a set parsing tool to obtain the logical topology map corresponding to the data processing logic.

The format transformation can be understood as transforming the data processing logic into data in a set syntax form, and the set syntax can be understood as a syntax corresponding to a set programming language. The set parsing tool can be an open-source syntax parser, such as Antlr (Another Tool for Language Recognition). The process of performing format transformation on the data processing logic can be: re-editing each field in the data processing logic according to the set syntax to obtain the target data processing logic in the set syntax. The parsing principle of the set parsing tool is not limited here. In this embodiment, format transformation is first performed on the data processing logic, which is conducive to perform parsing by using the set parsing tool directly, and thus improving the efficiency of data processing logic.

For example, the following code is a data processing logic in a set syntax:

```
  {
    ″expression″:″count(filter(relateditem(${issue}, {each}.${rStory}==${self}),
and(${each}.${pority}==\″P0\″,or(${each}.${state}.${name}==\″open\″,${each}.${state}$name}==\
″reopen\″))))″
  }
```

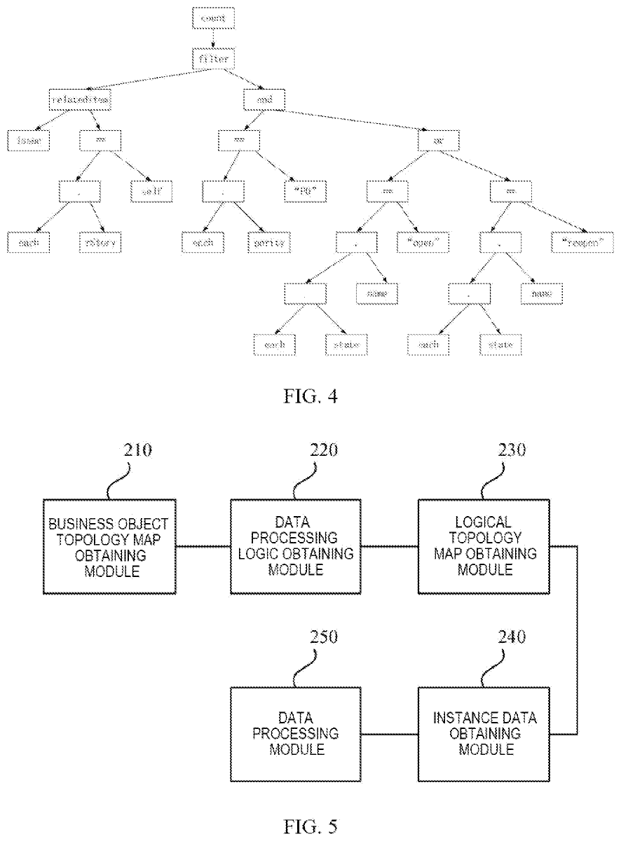

The above data processing logic is parsed by using the set parsing tool, and the logical topology map shown in FIG. 4 is obtained. As shown in FIG. 4, the logical map includes a plurality of logical nodes.

In this embodiment, each logical node in the logical topology map is structured data at the underlying data layer, and the structured data contains information such as node name, node identifier, node category (such as function type, variable type, or constant type), node data type (object type or non-object type), data structure type (such as single-element type or array type), sub-nodes, etc.

S140, obtaining instance data corresponding to the at least one business object.

The instance data can be understood as specific data of a business object, the business object can be understood as a variable, and the instance data can be understood as a specific value of the variable. In this embodiment, the method of obtaining instance data corresponding to the at least one business object can be: calling a data interface through identification information of the at least one business object to obtain instance data corresponding to the at least one business object.

S150, processing the instance data based on the logical topology map to obtain a processing result.

In this embodiment, when the logical topology map and instance data are obtained, the instance data of the at least one business object can be processed based on the logical topology map, that is, formula calculation can be performed on the instance data to obtain the processing result.

Optionally, the processing the instance data based on the logical topology map to obtain a processing result includes verifying the logical nodes in the logical topology map; and if the verification is passed, processing the instance data based on the logical topology map to obtain the processing result.

Verifying the logical nodes in the logical topology map can be understood as checking the logical nodes with a category of function type in the logical topology map. If all the logical nodes with the category of function type pass the verification, the verification of the logical topology map is passed. If there are logical nodes with the category of function type that fail to pass the verification, the verification of the logical topology map is not passed, which indicates that there is an error in the data processing logic edited by the user, thus promoting the user to modify the data processing logic. In this embodiment, the logical nodes in the logical topology map are verified first, and then subsequent data processing is performed if the verification is passed, thus the accuracy of data processing is ensured.

Optionally, the process of verifying the logical nodes in the logical topology map may include: traversing the logical nodes in the logical topology map to obtain categories of the traversed logical nodes; if the category of a traversed logical node is variable type or constant type, determining a data type of the logical node; and if the category of a traversed logical node is function type, verifying the logical node.

The categories include function type, variable type and constant type. The function type can be understood as that the logical node represents a function, for example, all of “—”, “.” and “count” are functions. The definition of various functions may refer to open-source rules, which are not limited here. The variable type can be understood as that the logical node represents a variable. The constant type can be understood as that the logical node represents a constant. Data types include object type and non-object type. Data types are classification on basic value types of data in computer programming languages, and non-object types include string type, number type, date type and Boolean type.

The logical nodes in the logical topology map can be traversed using Depth First Search (DFS) traversing. Depth First Search traversing may refer to the existing process, which is not limited here.

In this embodiment, if the category of a traversed logical node is the variable type or constant type, there is no need to perform verification, only the data type needs to be determined; if the category of a traversed logical node is the function type, verification needs to be performed. If the verification is passed, a data type of the function type logical node of is determined. In this embodiment, only the function type logical node is verified, which can improve the reliability and efficiency of verification.

Specifically, if the category of the traversed logical node is the variable type or the constant type, the determining the data type of the logical node may include: if the category of the traversed logical node is the variable type, obtaining attribute information of a business object corresponding to the logical node, and extracting the data type of the logical node from the attribute information; and if the category of the traversed logical node is the constant type, determining the data type of the logical nodes according to the constant.

Attribute information of a business object contains data types. When the category of the traversed logical node is the variable type, data type of a business object corresponding to the logical node can be used as the data type of the node. For example, if the business object is of object type, the logical node is of object type; and if the business object is of string type, the logical node is of string type. If the category of the traversed logical node is the constant type, the data type of a constant is first determined, and the data type of the constant is determined as the data type of the logical node. In this embodiment, different methods are used to determine the data type of the variable-type and constant-type logical nodes respectively, which can improve the accuracy of data type determination.

Specifically, if the category of the traversed logical node is the function type, verifying the logical node may include: if the category of the traversed logical node is the function type, obtaining a function category of the logical node and data types of sub-nodes of the logical node; verifying the data types of the sub-nodes based on the function category; and if the verification is passed, determining the data type of the logical node according to the function category.

The function category may include addition function, subtraction function, multiplication function, modulo function, division function, equality function, etc. The function-type logical node can be understood as using a function to perform operations on data of sub-nodes of the logical node. Therefore, the process of verifying the data types of the sub-nodes based on the function category may include: first, obtaining a corresponding rule of the function category, and then determining whether the data types of the sub-nodes meet the rule. If yes, the verification of the logical node is passed, otherwise, the verification is not passed.

The rule can be pre-set according to function operation rule, which specify the conditions that the data types of sub-nodes need to meet. For example, for the “==” function, the rule is that the data type of the left number of the equal sign is consistent with that of the right number of the equal sign. Therefore, if the function category of a logical node is “==”, it is necessary to determine whether the data types of two sub-nodes of the logical node are consistent. If they are consistent, the logical node is legal.

In this embodiment, the method of determining the data type of the logical node based on the function category may include: obtaining a type determination rule corresponding to the function category, and then determining the data type of a function type logical node based on the type determination rule. Different data categories correspond to different type determination rules. For example, a function category specify that the data type is consistent with the data type of their sub-nodes, and a function category specify that the data type is of a certain data type. For example, for the “==” function, its data type is specified as a Boolean type.

In this embodiment, the function type logical node is verified according to the verification of the data type of the sub-nodes based on the function category, thus the accuracy of the verification is improved.

Specifically, the processing the instance data based on the logical topology map to obtain a processing result, includes: traversing the logical topology map, and if a traversed logical node is of variable type or constant type, determining target information of the logical node; and if the category of a traversed logical node is the function type, determining target information of the logical node according to the function category, until traversing a root logical node of the logical topology map, and determining the target information of the root logical node as the processing result.

The target information of a logical node can be understood as the information or data involved in logical operations in the logical node. Logical nodes in the logical topology map can be traversed using Depth First Search (DFS) traversing. The depth-first traversing may refer to the existing process, which is not limited here.

Specifically, if the traversed logical node is of variable type or constant type, the method of determining the target information of the logical node may include: if the traversed logical node is of variable type and the data type is object type, obtaining the attribute information and sub-business objects of the business object corresponding to the logical node, and determining the attribute information and sub-business objects as the target information of the logical node; if the traversed logical node is of variable type and the data type is non-object type, obtaining instance data of the business object corresponding to the logical node and determining the instance data as the target information of the logical node; and if the traversed logical node is of constant type, determining the constant as the target information of the logical node.

It can be understood that the object-type data includes a plurality of sub-objects. In this embodiment, when the traversed logical node is of variable type and the data type is of object type, the attribute information and sub-business objects of the business object corresponding to the logical node are obtained, and the attribute information and sub-business objects are used as the target information of the logical node. For example, taking FIG. 4 as an example, assuming that the logical node “each” is traversed, and the data type of the logical node is object type, the attribute information and sub-business objects of “each” need to be extracted from the business object topology map, and the attribute information and sub-business objects are used as the target information of the “each” node. If the traversed logical node is of variable type and the data type is non-object type, instance data of a business object corresponding to the logical node is obtained through a data call interface, and the instance data is determined as the target information of the logical node. If the traversed logical node is of constant type, the constant is determined as the target information of the logical node. In this embodiment, for logical nodes of different categories and different data types, different methods are used to determine the target information, which is conducive to the accuracy of subsequent logical operations.

Specifically, if the category of the traversed logical node is a function type, the method of determining the target information of the logical node according to the function category may include: obtaining target information of the sub-nodes of the logical node; and processing the target information of the sub-nodes based on the function category to obtain the target information of the logical node.

The processing the target information of the sub-nodes based on the function category can be understood as performing an operation for the function category on the target information of the sub-nodes, thereby obtaining the target information of the logical node. As an example, assuming that the function category of a certain logical node is “addition function”, an addition operation is performed on the target information of its sub-nodes, and the results of the addition operation is determined as the target information of the logical node.

The technical solution of this embodiment obtains a business object topology map and display the business object topology map on a current interface, wherein the business object topology map comprises a plurality of business objects; receives data processing logic edited by a user for at least one business object in the business object topology map; parses the data processing logic to obtain a logical topology map corresponding to the data processing logic, wherein the logical topology map includes a plurality of logical nodes; obtains instance data corresponding to the at least one business object; and processes the instance data based on the logical topology map to obtain a processing result. The method for data processing provided in the embodiments of the present disclosure converts the data processing logic composed of at least one business object into a logical topology map, processes instance data of the at least one business object based on the logical topology map, and thus realizing logical processing capability in processing business data, and improving efficiency and accuracy of business data processing.

FIG. 5 is a structural schematic diagram of a data processing apparatus provided in an embodiment of the present disclosure, as shown in FIG. 5. The apparatus includes:
a business object topology map obtaining module 210 configured to obtain a business object topology map and display the business object topology map on a current interface; the business object topology map includes a plurality of business objects;
a data processing logic obtaining module 220 configured to receive data processing logic edited by a user for at least one business object in the business object topology map;
a logical topology map obtaining module 230 configured to parse the data processing logic to obtain a logical topology map corresponding to the data processing logic, where the logical topology map includes a plurality of logical nodes;
an instance data obtaining module 240 configured to obtain instance data corresponding to the at least one business object; and
a data processing module 250 configured to process the instance data based on the logical topology map to obtain a processing result.

Optionally, the logical topology map obtaining module 230 is also configured to:
perform format transformation on the data processing logic to obtain target data processing logic; and
parse the target data processing logic by using a set parsing tool to obtain the logical topology map corresponding to the data processing logic.

Optionally, the data processing module 250 is also configured to:
verify the logical nodes in the logical topology map; and
if the verification is passed, process the instance data based on the logical topology map to obtain the processing result.

Optionally, the data processing module 250 is also configured to:
traverse the logical nodes in the logical topology map to obtain categories of the traversed logical nodes, wherein the categories comprise a function type, a variable type and a constant type;
if the category of a traversed logical node is the variable type or the constant type, determine a data type of the logical node, wherein the data type comprises an object type and a non-object type; and
if the category of a traversed logical node is the function type, verify the logical node.

Optionally, the data processing module 250 is also configured to:
if the category of the traversed logical node is the variable type, obtain attribute information of a business object corresponding to the logical node, and extract the data type of the logical node from the attribute information; and
if the category of the traversed logical node is the constant type, determine the data type of the logical nodes according to a constant.

Optionally, the data processing module 250 is also configured to:
if the category of the traversed logical node is the function type, obtain a function category of the logical node and data types of sub-nodes of the logical node;
verify the data types of the sub-nodes based on the function category; and
if the verification is passed, determine the data type of the logical node according to the function category.

Optionally, the data processing module 250 is also configured to:
traverse the logical topology map, and if a traversed logical node is of variable type or constant type, determining target information of the logical node; and
if the category of a traversed logical node is the function type, determine target information of the logical node according to the function category, until traversing a root logical node of the logical topology map, and determine the target information of the root logical node as the processing result.

Optionally, the data processing module 250 is also configured to:
if the traversed logical node is of variable type and the data type is object type, obtain the attribute information and sub-business objects of the business object corresponding to the logical node, and take the attribute information and sub-business objects as the target information of the logical node;
if the traversed logical node is of variable type and the data type is non-object type, obtain instance data of the business object corresponding to the logical node, and take the instance data as the target information of the logical node; and
if the traversed logical node is of constant type, determine the constant as the target information of the logical node.

Optionally, the data processing module 250 is also configured to:
obtain target information of the sub-nodes of the logical node; and
process the target information of the sub-nodes based on the function category to obtain the target information of the logical node.

The data processing apparatus provided by the embodiment of the present disclosure may execute the method for data processing provided by any embodiment of the present disclosure, which has functional modules beneficial effects corresponding to the method for data processing.

It is worth noting that the various units and modules included in the above apparatus are only divided according to functional logic, however the present application is are not limited to the above division, as long as the corresponding functions can be realized; in addition, the specific names of each functional unit are only used for the sake of mutual distinction instead of limiting the scope of protection of the embodiments of the present disclosures.

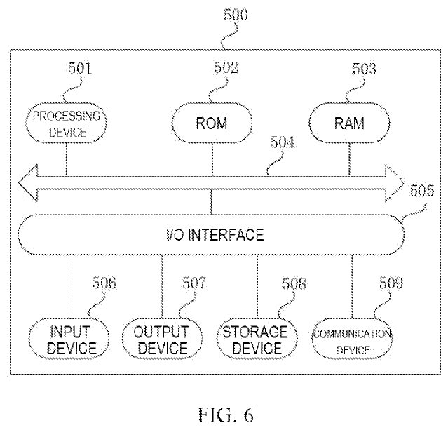

FIG. 6 is a structural schematic diagram of an electronic device provided in an embodiment of the present disclosure. Referring to FIG. 6 below, it is a structural schematic diagram of an electronic device (such as the terminal device or server in FIG. 6) suitable for implementing the embodiment of the present disclosure. The terminal device 500 in the embodiment of the present disclosure may include but is not limited to mobile terminals such as mobile phones, laptops, digital broadcast receivers, PDAs (Personal Digital Assistants), PADs (tablet computers), PMPs (portable multimedia players), car-mounted terminals (such as car navigation terminals), etc. and fixed terminals such as digital televisions (TV), desktop computers, etc. The electronic device shown in FIG. 6 is only an example and should not bring any limitation on the functionality and scope of use of the embodiment of the present disclosure.

As shown in FIG. 6, the electronic device 500 may include a processing device (such as a central processing unit, graphics processing unit, etc.) 501, which may perform various appropriate actions and processes based on programs stored in Read-Only Memory (ROM) 502 or loaded from storage device 508 into Random Access Memory (RAM) 503. In the RAM 503, various programs and data necessary for the operation of the electronic device 500 are also stored. The processing device 501, ROM 502, and RAM 503 are connected to each other through a bus 504. An Input/Output I/O interface 505 is also connected to the bus 504.

Typically, the following devices can be connected to I/O interface 505: input device 506 including, for example, touch screens, touchpads, keyboards, mice, cameras, microphones, accelerometers, gyroscopes, etc.; output device 507 including liquid crystal displays (LCDs), speakers, vibrators, etc.; storage device 508 including magnetic tapes, hard disks, etc.; and a communication device 509. The communication device 509 may allow the electronic device 500 to communicate with other devices wirelessly or wirelessly to exchange data. Although FIG. 6 shows an electronic device 500 with a plurality of devices, it shall be understood that it is not required to implement or have all of the devices shown. More or fewer devices can be implemented or provided instead.

In particular, according to embodiments of the present disclosure, the process described above with reference to the flowchart can be implemented as a computer software program. For example, an embodiment of the present disclosure includes a computer program product that includes a computer program carried on a non-transitory computer-readable medium, where the computer program includes program code for performing the method shown in the flowchart. In such an embodiment, the computer program can be downloaded and installed from a network through the communication device 509, or installed from the storage device 508, or installed from the ROM 502. When the computer program is executed by the processing device 501, the above functions defined in the method of the embodiment of the present disclosure are performed.

The names of the messages or information exchanged between a plurality of devices in the embodiment of the present disclosure are for illustrative purposes only and are not intended to limit the scope of these messages or information.

The electronic device provided in this embodiment of the present disclosure and the method for data processing provided in the above embodiments belongs to the invention idea. Technical details that are not described in detail in this embodiment can be found in the above embodiments, and this embodiment has the same beneficial effect as the above embodiments.

An embodiment of the present disclosure provides a computer storage medium on which a computer program is stored, when being executed by a processor, the program implements the method for data processing provided in the above embodiments.

It should be noted that the computer-readable medium described above can be a computer-readable signal medium or a computer-readable storage medium, or any combination thereof. The computer-readable storage medium can be, for example, but not limited to, an electrical, magnetic, optical, electromagnetic, infrared, or semiconductor system, apparatus, or device, or any combination thereof. Specific examples of computer-readable storage media may include but are not limited to: an electrical connection with one or more wires, a portable computer disk, a hard disk, random access memory (RAM), read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, a computer-readable storage medium may be any tangible medium containing or storing a program that can be used by an instruction execution system, apparatus, or device, or can be used in combination with an instruction execution system, apparatus, or device. In the present disclosure, a computer-readable signal medium can include a data signal propagated in baseband or as part of a carrier wave, which carries computer-readable program code therein. Such propagated data signals may take many forms, including but not limited to electromagnetic signals, optical signals, or any suitable combination thereof. A computer-readable signal medium may also be any computer-readable medium other than a computer-readable storage medium, which can send, propagate, or transmit programs for use by or in conjunction with instruction execution systems, apparatus, or devices. The program code contained on the computer-readable medium may be transmitted using any suitable medium, including but not limited to: wires, optical cables, RF (radio frequency), etc., or any suitable combination thereof.

In some embodiments, clients and servers can communicate using any currently known or future developed network protocol such as HTTP (HyperText Transfer Protocol), and can be interconnected with any form or medium of digital data communication (such as communication networks). Examples of communication networks include local area networks (“LANs”), wide area networks (“WANs”), internetworks (such as the Internet), and end-to-end networks (such as ad hoc end-to-end networks), as well as any currently known or future developed networks.

The computer-readable medium can be included in the electronic device, or it can exist alone without being assembled into the electronic device.

The above-mentioned computer-readable medium carries one or more programs, and when the above-mentioned one or more programs are executed by the electronic device, the electronic device:

The above-mentioned computer-readable medium carries one or more programs, and when the above-mentioned one or more programs are executed by the electronic device, the electronic device: obtain a business object topology map and display the business object topology map on a current interface; where the business object topology map includes a plurality of business objects; receive data processing logic edited by a user for at least one business object in the business object topology map; parse the data processing logic to obtain a logical topology map corresponding to the data processing logic; where the logical topology map includes a plurality of logical nodes; obtain instance data corresponding to the at least one business object; and process the instance data based on the logical topology map to obtain a processing result.

Computer program codes for performing the operations of the present disclosure may be written in one or more programming languages or a combination thereof, including but not limited to Object Oriented programming languages—such as Java, Smalltalk, C++, and also conventional procedural programming languages—such as “C” or similar programming languages. The program code may be executed entirely on the user's computer, partially executed on the user's computer, executed as a standalone software package, partially executed on the user's computer and partially on a remote computer, or entirely on a remote computer or server. In the case of involving a remote computer, the remote computer may be any kind of network—including local area network (LAN) or wide area network (WAN)—connected to the user's computer, or may be connected to an external computer (e.g., through an Internet service provider to connect via the Internet).

The flowcharts and block diagrams in the accompanying drawings illustrate the architecture, functions, and operations of possible implementations of the system, method, and computer program product according to various embodiments of the present disclosure. In this regard, each block in a flowchart or block diagram may represent a module, program segment, or portion of code that contains one or more executable instructions for implementing a specified logical function. It should also be noted that in some alternative implementations, the functions marked in the blocks may occur in a different order than those marked in the drawings. For example, two consecutive blocks may actually be executed in parallel, or they may sometimes be executed in reverse order, depending on the function involved. It should also be noted that each block in the block diagrams and/or flowcharts, as well as combinations of blocks in the block diagrams and/or flowcharts, may be implemented using a dedicated hardware-based system that performs the specified function or operations, or may be implemented using a combination of dedicated hardware and computer instructions.

The units described in the embodiments of the present disclosure may be implemented by means of software or hardware, and the name of the unit does not constitute a limitation on the unit itself in a certain case, for example, a first obtaining unit may also be described as “a unit for obtaining at least two internet protocol addresses”.

The functions described herein above can be performed at least in part by one or more hardware logic components. For example, without limitation, exemplary types of hardware logic components that may be used include: Field Programmable Gate Arrays (FPGAs), Application Specific Integrated Circuits (ASICs), Application Specific Standard Parts (ASSPs), System on Chip (SOCs), Complex Programmable Logic Devices (CPLDs), and so on.

In the context of this disclosure, a machine-readable medium can be a tangible medium that may contain or store programs for use by or in conjunction with instruction execution systems, apparatuses, or devices. A machine-readable medium may be a machine-readable signal medium or a machine-readable storage medium. A machine-readable medium may include, but are not limited to, electronic, magnetic, optical, electromagnetic, infrared, or semiconductor systems, apparatuses, or devices, or any suitable combination thereof. Specific examples of the machine-readable storage medium may include electrical connections based on one or more wires, portable computer disks, hard disks, random access memory (RAM), read-only memory (ROM), erasable programmable read-only memory (EPROM or flash memory), optical fibers, convenient compact disk read-only memory (CD-ROM), optical storage devices, magnetic storage devices, or any suitable combination thereof.

According to one or more embodiments of the present disclosure, a method for data processing is provided, which includes:
obtaining a business object topology map and displaying the business object topology map on a current interface; wherein the business object topology map comprises a plurality of business objects;
receiving data processing logic edited by a user for at least one business object in the business object topology map;
parsing the data processing logic to obtain a logical topology map corresponding to the data processing logic; wherein the logical topology map includes a plurality of logical nodes;
obtaining instance data corresponding to the at least one business object; and
processing the instance data based on the logical topology map to obtain a processing result.

Furthermore, the parsing the data processing logic to obtain a logical topology map corresponding to the data processing logic includes:
performing format transformation on the data processing logic to obtain target data processing logic; and
parsing the data processing logic by using a set parsing tool to obtain the logical topology map corresponding to the data processing logic.

Furthermore, the processing the instance data based on the logical topology map to obtain a processing result includes:
verifying the logical nodes in the logical topology map; and
if the verification is passed, processing the instance data based on the logical topology map to obtain the processing result.

Furthermore, the verifying the logical nodes in the logical topology map includes:
traversing the logical nodes in the logical topology map to obtain categories of the traversed logical nodes, wherein the categories comprise a function type, a variable type and a constant type;
if the category of a traversed logical node is the variable type or the constant type, determining a data type of the logical node, wherein the data type comprises an object type and a non-object type; and
if the category of a traversed logical node is the function type, verifying the logical node.

Furthermore, the determining the data type of a traversed logical node if the category of the logical node is the variable type or the constant type includes:
if the category of the traversed logical node is the variable type, obtaining attribute information of a business object corresponding to the logical node, and extracting the data type of the logical node from the attribute information; and
if the category of the traversed logical node is the constant type, determining the data type of the logical nodes according to the constant.

Furthermore, the verifying the logical node if the category of the logical node is the function type includes:
if the category of the traversed logical node is the function type, obtaining a function category of the logical node and data types of sub-nodes of the logical node;
verifying the data types of the sub-nodes based on the function category; and
if the verification is passed, determining the data type of the logical node according to the function category.

Furthermore, the processing the instance data based on the logical topology map to obtain a processing result comprises:
traversing the logical topology map, and if a traversed logical node is of variable type or constant type, determining target information of the logical node; and
if the category of a traversed logical node is the function type, determining target information of the logical node according to the function category, until traversing a root logical node of the logical topology map, and determining the target information of the root logical node as the processing result.

Furthermore, the traversing the logical topology map, and if the traversed logical node is of variable type or constant type, determining target information of the logical node, includes:
if the traversed logical node is of variable type and the data type is object type, obtaining the attribute information and sub-business objects of the business object corresponding to the logical node, and determining the attribute information and sub-business objects as the target information of the logical node;
if the traversed logical node is of variable type and the data type is non-object type, determining instance data of the business object corresponding to the logical node as the target information of the logical node; and
if the traversed logical node is of constant type, determining the constant as the target information of the logical node.

Furthermore, the determining target information of the traversed logical node according to the function category, if the category of the logical node is function type, includes:
obtaining target information of the sub-nodes of the logical node; and
processing the target information of the sub-nodes based on the function category to obtain the target information of the logical node.

The above description is only embodiments of this disclosure and an explanation of the technical principles used. Those skilled in the art should understand that the scope of the disclosure involved in this disclosure is not limited to technical solutions composed of specific combinations of the above technical features, but should also covers other technical solutions formed by arbitrary combinations of the above technical features or their equivalent features without departing from the above disclosure concept. For example, technical solutions formed by replacing the above features with (but not limited to) technical features with similar functions disclosed in this disclosure.

In addition, although a plurality of operations are depicted in a specific order, this should not be understood as requiring these operations to be performed in the specific order shown or in a sequential order. In certain environments, multitasking and parallel processing may be advantageous. Similarly, although a plurality of implementation details are included in the above discussion, these should not be construed as limiting the scope of the present disclosure. Some features described in the context of individual embodiments can also be implemented in combination in a single embodiment. Conversely, a plurality of features described in the context of a single embodiment can also be implemented in a plurality of embodiments separately or in any suitable sub-combination.

Although the subject matter has been described in language specific to structural features and/or methodological logical actions, it should be understood that the subject matter defined in the appended claims is not necessarily limited to the specific features or actions described above. On the contrary, the specific features and actions described above are merely example forms of implementing the claims.

I/We claim:

1. A method for data processing, comprising:
obtaining a business object topology map and displaying the business object topology map on a current interface; wherein the business object topology map comprises a plurality of business objects;
receiving data processing logic edited by a user for at least one business object in the business object topology map;
parsing the data processing logic to obtain a logical topology map corresponding to the data processing logic; wherein the logical topology map comprises a plurality of logical nodes;
obtaining instance data corresponding to the at least one business object; and
processing the instance data based on the logical topology map to obtain a processing result.

2. The method of claim 1, wherein parsing the data processing logic to obtain the logical topology map corresponding to the data processing logic comprises:
performing format transformation on the data processing logic to obtain target data processing logic; and
parsing the target data processing logic by using a set parsing tool to obtain the logical topology map corresponding to the data processing logic.

3. The method of claim 1, wherein processing the instance data based on the logical topology map to obtain the processing result comprises:
verifying the logical nodes in the logical topology map; and
if the verification is passed, processing the instance data based on the logical topology map to obtain the processing result.

4. The method of claim 3, wherein verifying the logical nodes in the logical topology map comprises:
traversing the logical nodes in the logical topology map to obtain categories of the traversed logical nodes, wherein the categories comprise a function type, a variable type and a constant type;
determining a data type of the logical node if the category of a traversed logical node is the variable type or the constant type, wherein the data type comprises an object type and a non-object type; and
verifying the logical node if the category of a traversed logical node is the function type.

5. The method of claim 4, wherein determining the data type of the traversed logical node if the category of the logical node is the variable type or the constant type comprises:
if the category of the traversed logical node is the variable type, obtaining attribute information of a business object corresponding to the logical node, and extracting the data type of the logical node from the attribute information; and
if the category of the traversed logical node is the constant type, determining the data type of the logical nodes based on the constant.

6. The method of claim 4, wherein verifying the traversed logical node if the category of the logical node is the function type comprises:
if the category of the traversed logical node is the function type, obtaining a function category of the logical node and data types of sub-nodes of the logical node;
verifying the data types of the sub-nodes based on the function category; and
if the verification is passed, determining the data type of the logical node based on the function category.

7. The method of claim 6, wherein processing the instance data based on the logical topology map to obtain the processing result comprises:
traversing the logical topology map, and if a traversed logical node is of the variable type or the constant type, determining target information of the logical node; and
if the category of a traversed logical node is the function type, determining target information of the logical node based on the function category until traversing a root logical node of the logical topology map, and determining the target information of the root logical node as the processing result.

8. The method of claim 7, wherein traversing the logical topology map, and if the traversed logical node is of the variable type or the constant type, determining target information of the logical node comprises:
if the traversed logical node is of the variable type and the data type is the object type, obtaining attribute information and sub-business objects of a business object corresponding to the logical node, and determining the attribute information and sub-business objects as the target information of the logical node;
if the traversed logical node is of the variable type and the data type is the non-object type, determining instance data of a business object corresponding to the logical node as the target information of the logical node; and
if the traversed logical node is of the constant type, determining the constant as the target information of the logical node.

9. The method of claim 7, wherein determining target information of the traversed logical node according to the function category if the category of the logical node is the function type comprises:
obtaining target information of the sub-nodes of the logical node; and
processing the target information of the sub-nodes based on the function category to obtain the target information of the logical node.

10. An electronic device comprising:
one or more processors;
a storage apparatus for storing one or more programs,
when the one or more programs are executed by the one or more processors, the one or more processors implement a method for data processing comprising:
obtaining a business object topology map and displaying the business object topology map on a current interface; wherein the business object topology map comprises a plurality of business objects;
receiving data processing logic edited by a user for at least one business object in the business object topology map;
parsing the data processing logic to obtain a logical topology map corresponding to the data processing logic; wherein the logical topology map comprises a plurality of logical nodes;
obtaining instance data corresponding to the at least one business object; and
processing the instance data based on the logical topology map to obtain a processing result.

11. The electronic device of claim 10, wherein parsing the data processing logic to obtain the logical topology map corresponding to the data processing logic comprises:
performing format transformation on the data processing logic to obtain target data processing logic; and
parsing the target data processing logic by using a set parsing tool to obtain the logical topology map corresponding to the data processing logic.

12. The electronic device of claim 10, wherein processing the instance data based on the logical topology map to obtain the processing result comprises:
verifying the logical nodes in the logical topology map; and
if the verification is passed, processing the instance data based on the logical topology map to obtain the processing result.

13. The electronic device of claim 12, wherein verifying the logical nodes in the logical topology map comprises:
traversing the logical nodes in the logical topology map to obtain categories of the traversed logical nodes, wherein the categories comprise a function type, a variable type and a constant type;
determining a data type of the logical node if the category of a traversed logical node is the variable type or the constant type, wherein the data type comprises an object type and a non-object type; and
verifying the logical node if the category of a traversed logical node is the function type.

14. The electronic device of claim 13, wherein determining the data type of the traversed logical node if the category of the logical node is the variable type or the constant type comprises:
if the category of the traversed logical node is the variable type, obtaining attribute information of a business object corresponding to the logical node, and extracting the data type of the logical node from the attribute information; and
if the category of the traversed logical node is the constant type, determining the data type of the logical nodes based on the constant.

15. The electronic device of claim 13, wherein verifying the traversed logical node if the category of the logical node is the function type comprises:
if the category of the traversed logical node is the function type, obtaining a function category of the logical node and data types of sub-nodes of the logical node;
verifying the data types of the sub-nodes based on the function category; and
if the verification is passed, determining the data type of the logical node based on the function category.

16. The electronic device of claim 15, wherein processing the instance data based on the logical topology map to obtain the processing result comprises:
traversing the logical topology map, and if a traversed logical node is of the variable type or the constant type, determining target information of the logical node; and
if the category of a traversed logical node is the function type, determining target information of the logical node based on the function category until traversing a root logical node of the logical topology map, and determining the target information of the root logical node as the processing result.

17. The electronic device of claim 16, wherein traversing the logical topology map, and if the traversed logical node is of the variable type or the constant type, determining target information of the logical node comprises:
if the traversed logical node is of the variable type and the data type is the object type, obtaining attribute information and sub-business objects of a business object corresponding to the logical node, and determining the attribute information and sub-business objects as the target information of the logical node;
if the traversed logical node is of the variable type and the data type is the non-object type, determining instance data of a business object corresponding to the logical node as the target information of the logical node; and
if the traversed logical node is of the constant type, determining the constant as the target information of the logical node.

18. The electronic device of claim 16, wherein determining target information of the traversed logical node according to the function category if the category of the logical node is the function type comprises:
obtaining target information of the sub-nodes of the logical node; and
processing the target information of the sub-nodes based on the function category to obtain the target information of the logical node.

19. A non-transitory storage medium containing computer-executable instructions, when executed by a computer processor, the computer-executable instructions perform a method for data processing comprising:
obtaining a business object topology map and displaying the business object topology map on a current interface; wherein the business object topology map comprises a plurality of business objects;
receiving data processing logic edited by a user for at least one business object in the business object topology map;
parsing the data processing logic to obtain a logical topology map corresponding to the data processing logic; wherein the logical topology map comprises a plurality of logical nodes;
obtaining instance data corresponding to the at least one business object; and
processing the instance data based on the logical topology map to obtain a processing result.

20. The non-transitory storage medium of claim 19, wherein parsing the data processing logic to obtain the logical topology map corresponding to the data processing logic comprises:
performing format transformation on the data processing logic to obtain target data processing logic; and
parsing the target data processing logic by using a set parsing tool to obtain the logical topology map corresponding to the data processing logic.
